(19) United States
(12) Patent Application Publication
(10) Pub. No.: US 2003/0097286 A1
(43) Pub. Date: May 22, 2003

(54) Model driven collaborative business application development environment and collaborative applications developed therewith

(75) Inventor: Marion Dale Skeen, Atherton, CA (US)

Correspondence Address: NIXON PEABODY, LLP, 8180 GREENSBORO DRIVE, SUITE 800, MCLEAN, VA, 22102, US

(73) Assignee: VITRIA TECHNOLOGIES, INC.

(21) Appl. No.: 10/273,359

(22) Filed: Oct. 18, 2002

Related U.S. Application Data
(60) Provisional application No. 60/329,765, filed on Oct. 18, 2001.

(51) Int. Cl. G06F 17/60

(52) U.S. Cl. 705/7

(57) ABSTRACT

A model driven environment for creating collaborative applications for executing collaborative business processes. Interrelated models are configured to define the application. A business process model defines steps and rules of the business process. A vocabulary model defines document flows corresponding to the business process. A service model exposes external events of the business process to other parties in the form of specifications. Trading partners can subscribe to the specifications to collaborate.

### RELATED APPLICATION DATA

This application is a continuation in part of application Ser. No. 09/984,977 entitled Integrated Business Process Modeling Environment and Models Created Thereby filed on Oct. 31, 2001, the disclosure of which is hereby incorporated by reference. This application claims benefit of provisional application Serial No. 60/329,765 filed on Oct. 18, 2001, the disclosure of which is also incorporated herein by reference.

### COPYRIGHT NOTICE

This application contains material that is subject to copyright protection. The copyright owner has no objection to the facsimile reproduction by anyone of the document or disclosure, as it appears in the Patent and Trademark Office Records, but otherwise reserves all copyrights whatsoever.

### BACKGROUND

The present invention relates generally to collaborative business applications and more specifically to a model-driven environment for developing collaborative business applications and model-driven collaborative applications.

It is well known to automate various business systems, such as Customer Relations Management (CRM), Enterprise Resource Planning (ERP), accounting, inventory control, order processing and the like. Historically, such systems were each handled by dedicated software programs that did not integrate well with each other. Early software programs for automating business systems were designed to run independently, with no interaction between various systems. Such programs were custom built for a specific need being addressed and often utilized proprietary protocols. Dedicated “point to point” connections were developed to permit each such system to communicate with another such system. For example, an inventory control system may exchange data with an accounting system through a customized software interface. However, as the number of systems increases, the quantity and complexity of point to point connections also increase. Further, point to point connections are rather inflexible and do not facilitate reconfigurations of systems to accommodate changing business processes.

The concept of “Enterprise Application Integration” (EAI) refers to the sharing of data throughout applications and data sources within an organization. As enterprises grow and require increased flexibility of data sharing throughout various systems, EAI is used to streamline processes and keep all the elements of the enterprise interconnected. EAI can include database linking, application linking, and data warehousing. Various systems for accomplishing EAI are well known. For example, Service Oriented Architectures (SOA), in which a common set of services are exposed by different layers, are known. Also, Event Oriented Architectures (EOA) in which a publish/subscribe messaging system is used to change the states of activities based on events, is known. Further, standard connectivity protocols and message formats such as Remote Method Invocation (RMI) and extensible Markup Language (XML) have been established to facilitate EAI.

It is also known to provide an object oriented environment for modeling and configuring the above-described integration of various applications in a graphical manner to further facilitate configuration and reconfiguration of business systems. For example, the BusinessWare™ modeling environment sold by Vitria™ Technology, Inc. permits modeling of the integration of applications in a graphical manner by using “business process models,” a technique becoming known as “business process management” (BPM). Business processes can span multiple applications and locations. An objective of BPM is to optimize the various capabilities that exist in business organizations and eliminate the various impediments from which organizations tend to suffer, such as lack of timely information and communication between various systems.

In order for parties seeking to do business, i.e. trading partners, to communicate and conduct business with one another, business to business (B2B) applications have been developed. Such applications permit the exchange of data, in the form of documents, between trading partners in a predetermined manner in order to facilitate electronic commerce. For example, electronic commerce through automated data interchange is well known. Many large companies have effected electronic commerce for many years using a data interchange format known as “Electronic Data Interchange” (EDI). EDI has proven itself to be very effective. In a typical EDI implementation, various back end information technology systems in a business, such as a CRM system, a billing system, an inventory control system, and the like, are coupled to an “EDI mapper” which is preprogrammed to create an electronic document in a standard EDI document format. Once this is accomplished, the document can be grouped with other documents in a “mail bag” for transmission to the specified trading partner(s).

Transmission of EDI documents is generally accomplished through a third-party network service, known as a “Value Added Network” or VAN. The VAN is a secure network that serves as a clearinghouse for electronic transactions. Therefore, a trading partner can send all of their documents to a single destination, i.e. the VAN. The documents are placed in an outbox and the VAN pulls the documents in batch mode at periodic intervals. The VAN then routes each document to an electronic inbox. If the intended recipient trading partner does not subscribe to the particular VAN used by the sending trading partner, the transaction can be routed from one VAN to another VAN and then to the appropriate inbox. The recipient trading partner must then “pull,” i.e. affirmatively request the document from their inbox to receive the documents.

EDI is a serial process in which documents are generated from back end systems in response to receipt of other documents. For example an EDI 850 document is a purchase order. When an 850 is sent from a customer to a supplier through the VAN, an EDI 855 purchase order acceptance is generated by the supplier's EDI mapper by pulling the requisite information from the supplier's back end information technology systems, such as inventory systems, and the like. Further, EDI is a “point-to-point” standard. More specifically, EDI transactions are between a pair of trading partners and are not easily shared with other interested partners. If the order of document generation is to be changed, the trading partners must agree to the change and implement the change in each of their back end EDI systems.

More recently, the popularity of the Internet and extensible markup language (XML) have given rise to methods of data interchange that are less expensive than EDI and thus have lowered the barriers to entry for accomplishing B2B data interchange. Many B2B systems currently are based on XML. Similar to EDI systems, these newer systems allow the internal applications of different companies to share information directly and thus eliminate the need for manual communication relating to transactions. Data is placed between descriptive XML tags as metadata. XML messages are thus rich in metadata making them easy to read and debug. Further, the relative simplicity of XML permits persons with limited training to develop and maintain XML-based applications, in turn making XML applications less expensive to implement. However, there are plural XML “standard” data formats and thus the use of XML does not, in itself, provide compatibility between systems.

It is also known to interface XML and EDI based systems. For example, the XML-EDI Group, ANSI, Ariba™, CommerceOne™ and Edifecs Commerce™ have proposed various approaches for translating EDI messages into an XML format. Edifecs has develop Guideline XML.(gXML) to facilitate the exchange of EDI implementation guidelines using XML. Therefore, XML and EDI translations into XML are not standardized. This requires that data structures be translated and/or transformed to provide integration of disparate systems.

The concept of “value chains,” i.e., a series of business activities that create value, has become a useful paradigm for analyzing and improving the efficiency of businesses. Such activities include business processes, such as order entry, shipping, invoicing, CRM, and the like. Value chains are dependent on the internal business processes of a company, the business processes of trading partners, such as suppliers, and the relationship between the company and trading partners. It has become popular to experiment with and change value chains to optimize efficiency and profitability. Such change requires reconfiguration of business processes and the integration therebetween. EAI has facilitated such reconfiguration of business systems within each organization.

A primary objective of many vendors is to provide business collaboration between trading partners. This has given rise to the concept of a “collaboration application”. For example, U.S. patent publication 0010741A1 discloses a commerce system in which workflows of various trading partners are integrated. However, this system is not model driven and thus require sspecialized plug-in code.

As noted above, collaboration is currently achieved using plural products, solutions, and systems. For example, IBM™ distributes WebSphere MQ™ for application integration, WebSphere Process Manager™ for business process management, WebSphere Business Integrator™ for B2B solutions and other products to facilitate collaboration between trading partners. Similarly, SeeBeyond™ distributes e*Gate Integrator™ for application integration, e*Insight Business Process Manager™ for providing modeling of business processes and management and other products to provide a collaboration solution. Other vendors, such as TIBCO™, WebMethods™ and BEA Systems™, provide various products for application integration, business process management, and B2B. Communication is defined by various transformation and adapter products thus further complicating known solutions for business collaboration.

Known solutions require plural products and specialized integration between existing systems of trading partners in order to provide collaboration. The disparate data structures and formats of various applications to be integrated often requires complex data transformations. Various methods for accomplishing such transformations are well known. However, such methods require complex programming techniques. Further, while business processes and application integration can be structured, i.e. captured in a model, collaboration has been ad hoc, i.e., not capturable in models due to the complexities noted above. Therefore, the concept of a model driven “collaboration application” has not been achieved.

### SUMMARY OF THE INVENTION

It is an object of the invention to increase the flexibility of business collaboration by permitting business collaboration applications to be developed in a model driven environment. To achieve this and other objects, a first aspect of the invention is a model driven environment for executing collaborative business applications through which participants can execute business processes. The system comprises a business process module operative to execute business process models representing collaborative business processes, a vocabulary module including a vocabulary model defining common terms and transformations to be used in exchanging documents to be used for transactions, and a services module including a services model representing external events corresponding to states of the business process models executed by the business process model execution module in conformance with the vocabulary models and corresponding transformations.

### BRIEF DESCRIPTION OF THE DRAWING

The invention is described through a preferred embodiment and the attached drawing in which:

FIG. 1 is a block diagram of a computer architecture of the preferred embodiment;

FIG. 2 is an example of a process model of the preferred embodiment;

FIG. 3 schematically illustrates a services model for the process model of the example of FIG. 2;

FIG. 4 is a block diagram of service implementation of the preferred embodiment;

FIG. 5 illustrates an example of a vocabulary models of the preferred embodiment; and

FIG. 6 schematically illustrates the document flow of the preferred embodiment.

### GLOSSARY

The following description uses terms of art which are defined below:

Business Collaboration—The process of exchanging information between trading partners to effect business transactions.

Business Collaboration Application—An executable software application for effecting business collaboration.

Business Process Model—A state machine that models business processes at a semantic level and defines an executable specification for the underlying business logic.

Model—A representation in a certain form that captures the important aspects of the thing being modeled from a certain point of view and simplifies the rest.

Translation—Changing data from one format to another without affecting data structure.

Transformation—Changing the semantics of a data structure.

Semantics—The underlying concepts and meaning of data elements.

Services—A specification of external touchpoints of a business process.

Simple Object Access Protocal (SOAP)—A protocol that provides a way for applications to communicate with each other over the Internet, independent of platform. SOAP relies on XML to define the format of the information and then adds the necessary HTTP headers to send it.

Trading Partner—An entity participating in a business transaction.

### DETAILED DESCRIPTION

Applicant has discovered that collaborative business flow between trading partners can be captured through a series of interrelated models. Accordingly, models can be used to define a collaborative application. Such models are referred to herein as the “vocabulary model,” the “services model,” and the “process model” herein. Each of these models will be described in greater detail below with respect to a preferred embodiment. While examples of such models, in isolation, are known, applicant has combined the models in a unique way and defined the interrelation therebetween to achieve a truly model driven collaborative application.

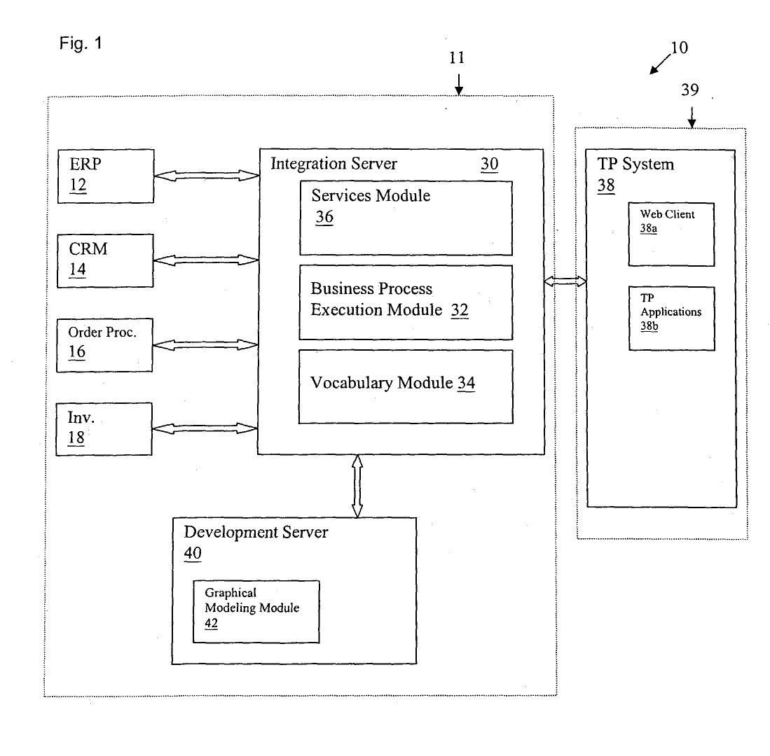

FIG. 1 illustrates architecture 10 for developing, and executing business collaboration applications in a model driven environment. Business process systems, such as ERP system 12, CRM system 14, order processing system 16, and inventory system 18 control associated applications of an organization of a trading partner, supplier 11 in the preferred embodiment, and are coupled to integration server 30 of supplier 11 over a local area network (LAN) or other communication channel within the organization. In addition, trading partner system 38, such as the integration server and other systems of an external trading partner, customer 39 in the preferred embodiment, is coupled to integration server 30 over the Internet or other communication channel, such as a wide area network (WAN). Integration server 30 can be coupled to development server 40 of supplier 11 through appropriate communication channels such as a LAN. Alternatively, the functionality of development server 40 (described below) can be accomplished within integration server 30 or from a remote location. Trading partner system 38 of customer 39 includes a Web client 38a for communications over the Internet, and trading partner business processes 38b (such as inventory, order processing and the like). Trading partner business processes 38b can include computer systems for controlling various business functions of customer 39.

Development server 40 includes graphical modeling module 42, in the form of software, which provides the modeling environment, including a user interface, for configuring business process models, vocabulary models, a services models. Modeling module 42 can be similar to the modeling module disclosed in the parent application Ser. No. 09/984,977. Modeling module 42 can include the appropriate user interfaces, such as a graphical user interface (GUI) for permitting the appropriate models to be configured, edited, and managed. The models can be configured in any order and in an iterative manner to achieve the desired interrelation therebetween, as described below. Integration server 30 includes business process model execution module 32 for executing business process developed by development server 40 to direct the flow of information between supplier 11, customer 39, and any other trading partners wishing to collaborate.

After defining the collaborative business processes that need to be automated, a developer then creates graphical models of those processes with graphical modeling module 42. Because the development process is model driven, the “developer” need not have programming skills and can focus on the business requirements of the application. The resulting business process models consist of plural states and transitions defining the logic that is executed to move an instance of the business process model from one state to the next state, as described below. Modeling module 42 can include predefined business process models, such as models graphical designed for a specific industry or a specific business relationship.

Integration server 30 also includes a messaging layer or infrastructure for integration server 30 and systems 12, 14, 16, 18, and 38. For example, an event-driven publish-subscribe methodology can be deployed via communications channels to transport information between systems. In the case of communication with external systems, data can be transformed by vocabulary module 34, in the manner described below, and transported in an encrypted form over various networks using standard protocols.

Vocabulary module 34 of integration server 30 defines standard semantics, e.g. common values, terms, documents, and document flows, to be used for message exchange between systems. For example, vocabulary module 34 can include a standard vocabulary of words and corresponding meanings to permit message exchange between systems using disparate messaging formats, EDI and various forms of XML for example. Vocabulary module 34 and the function thereof are described in greater detail below.

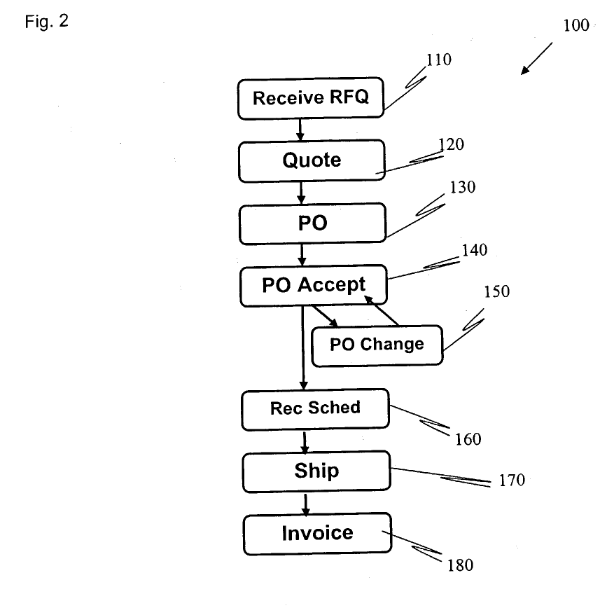

FIG. 2 illustrates an example of a business process model of a collaborative application used with the preferred embodiment. Process model 100 has plural states 110, 120, 130, 140, 150, 160, 170, and 180 connected by transitions represented by arrows in FIG. 2. Transitions define the logic that is executed to move an instance of the process model from one state to the next state. For example, transitions can include the logic for transmitting messages or confirming the receipt of messages required to move to the next state as is well known. Examples of the logic defined by transitions is discussed in detail in application Ser. No. 09/984,977, the disclosure of which is incorporated herein by reference. The various states of business process model 100 and the underlying business process will be described in greater detail below in connection with the services model and the vocabulary model.

It can be seen that process model 100 is a supplier-centric model, i.e. includes states of a suppliers business process such as PO Accept state 140, Ship state 170, and Invoice state 180. However, process model 100 can be represented as external events generated and received while hiding internal events to permit collaboration with trading partners, such as customer 39. These external events can be characterized as a services model defining external touchpoints of the business process represented by business process model 100.

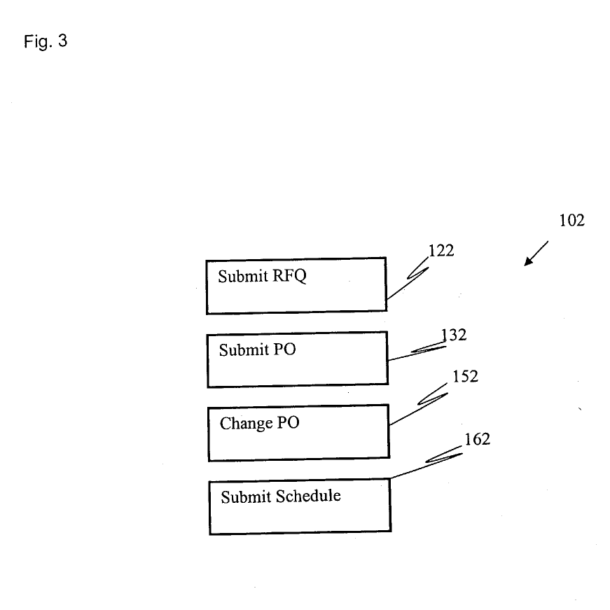

FIG. 3 illustrates services model 102 of by services module 36 in the preferred embodiment. Services model 102 includes Submit RFQ service 122 (corresponding to states 110 and 120 of business process model 100), Submit PO service 132 (corresponding to states 130 and 140 of business process model 100), Change PO service 152 (corresponding to state 150 of business process model 100), and Schedule service 162 (corresponding to state 160 of business process model 100). Since business process model 100 of the preferred embodiment is supplier centric, services of services model 102 represent the external events required by customer 39 required to comply with the supplier centric business process represented by business process model 100. It can be seen that the services do not include shipping, invoicing, or other events that that represent internal actions to be taken by the supplier. The services 102 can be expressed through an interface definition language, or any other type of specification.

For example Web Services Description Language (WSDL) is a known XML format for describing services as a set of endpoints operating on messages containing either document-oriented or procedure-oriented information, e.g., events. The operations and messages are described abstractly, and then bound to a concrete network protocol and message format to define an endpoint. Related concrete endpoints are combined into abstract endpoints known as “services.”

Services module 36 is used to generate services that define the interaction between trading partners necessary to execute business process model 100 in a collaborative manner. The services can be published by services module 36 for examination and adoption by trading partners in an automated fashion in a known manner. Services can be published as WSDL or in any other manner.

For example, WSDL includes the following seven basic elements which are used to define a service:

Service—a collection of related ports;

2) Message—a typed definition of the data being communicated;

3) Operation—a description of the actions supported by the service;

4) Binding—protocol and data format definitions;

5) Types—a container for data type definitions;

6) Port—a network address or URI to be used as an endpoint; and

7) Port Type—a set of operations supported by the endpoints.

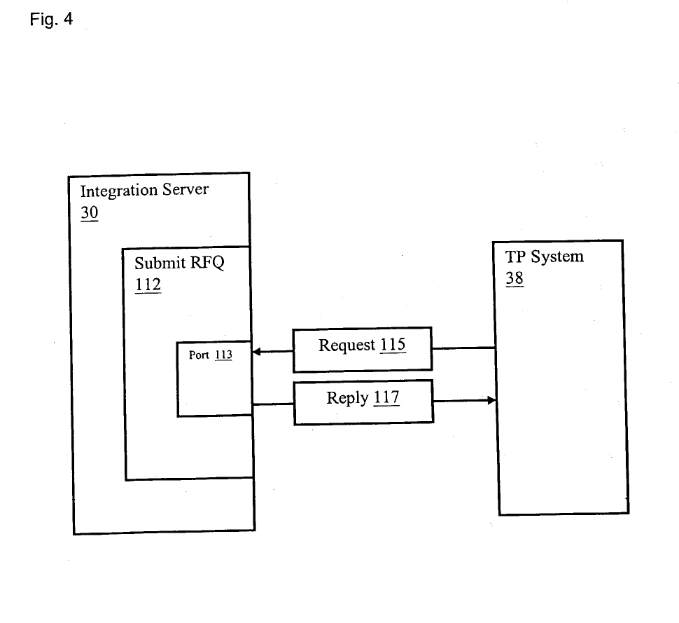

Through these elements WSDL is used to describe the service, specify its location, and describe the operations it exposes. Services described through WSDL can be invoked in various ways, such as through Simple Object Access Protocol (SOAP) or using HTTP GET. A service invocation ordinarily consists of a request and a response message. FIG. 4 schematically illustrates invocation of a service by trading partner 38 from integration server 30. The example of FIG. 4 illustrates Submit RFQ service 112 only for the purpose of clarity. However, all services of service model 102 can be exposed and invoked in a similar manner.

As illustrated in FIG. 4, service 112 exposes at least one port 113, i.e., endpoint, which is described in greater detail below. As noted above, port 113 is a network address for message communication. Port 113 includes a port type and binding to completely define an endpoint. In accordance with service 112, request message 115 is passed from trading partner system 38 to integration server 30 and reply message 117 is returned in response to request message 115. In the example of service 112, which is a request for quote service, request message 115 can be a document specifying goods to be quoted, in a form defined by a vocabulary model of vocabulary module 34, and reply message 117 can be a quote document. For example, in the preferred embodiment, request message 115 includes a Request for Quote document and reply message 117 includes a Reply to Request for Quote document as defined by document model 106 discussed below.

A <definitions> element is the root element of the WSDL document which declares the WSDL namespace as the default namespace for the document. To describe service 122 using WSDL the WSDL <service> element is used. All WSDL elements belong to the WSDL namespace, which is defined as: http://schemas.xmlsoap.org/wsdl/. Submit RFQ service 122 can be described as follows:

<definitions name =‘SubmitRFQ’ xmlns=‘http://schemas.xmlsoap.org/wsdl/’>

<service name=‘SubmitRFQ’>
</service>

</definitions>

Each service is defined using a WSDL <service> element which specifies the name of the port, or plural ports, on which the service is accessible using the <port> element. As noted above, a port, port 113 in FIG. 4 for example, specifies the name of the service address. The defintion of port 113 is set forth below:

<port name=‘Port113’ binding=‘wsdlns:SubmitRFQSOAPBinding’>

<soap:address

location=‘http://localhost/demos/wsdl/vitria/submitrfq.asp’/>
</port>

Each port has a unique name and a binding attribute as described below. If SOAP is used to invoke the service, the <port> element contains a <soap:address/> element with the actual service address. The namespace specified in the Soap address element is used for SOAP-specific elements within WSDL. As noted above, a service does not have to be exposed using SOAP and thus need not include this element. Also, a service may be accessible on many ports to provide for invoking the service through different protocols. For example, SOAP, HTTP GET and SMTP can be used to invoke a service.

The protocol of messages 115 and 117 is independent of the protocol used to invoke service 122. However, the message structure must be defined in order to fully define the service. In WSDL, the <message> element is used to define the message structure and contains zero or more <part> elements. A <part> corresponds to a parameter or a return value. For example, request message 115 will contain all ByVal and ByRef parameters and response message 117 will contain all ByRef parameters as well as the return value. Each <part> element ordinarily has the same name and data type as the parameter it represents. For example, the message structure of service 122 is set for the below;

<message name=‘RFQ.GetPrice’>

<part name=‘widget1’/>

</message>
<message name=‘RFQ.GetPriceResponse’>

<part name=‘Price’/>

</message>

The WSDL <operation> element serves to tie messages 115 and 117 together as a request-response pair corresponding to service 122. An operation specifying which message is the input and which message is the output, using <input> and <output> elements, is set forth below:

<operation name=‘SubmitRFQ’>

<input message=‘RFQ.GetPrice’/>
<output message=‘RFQ.GetPriceResponse’/>

</operation>

The collection of all operations exposed by a service is called a “Port Type” and is defined using the WSDL <portType> element as set for the below:

<portType name=‘SubmitRFQSoapPort’>

<operation name=‘GetPrice’>

<input message=‘RFQ.GetPrice’/>
<output message=‘RFQ.GetPriceResponse’/>

</operation>

</portType>

The elements described above, can be said to describe abstract data types, messages, and operations. However, these must be bound to concrete physical representation of messages in order to use services in a deployed application. To define the concrete aspects of services the WSDL <binding> element can be used as set forth below:

<binding name=‘SubmitRFQSoapBinding’ type=‘wsdins:SubmitRFQSoapPort’>

</binding>

Note that the value used for the binding attribute on the <port> element is the same as the name attribute of the <binding> element. Inside the <binding> element is a WSDL SOAP extension element called <soap:binding> which is used to specify the transport protocol (e.g., HTTP, SMTP, or the like).

Service 122 can include additional details not discussed above, such as how messages are physically represented (as defined by vocabulary module 34), the form and type of variables, and the like. Further, while the example above was described using WSDL conventions, services can be expressed in any manner that is understood by the parties using the services and which provides enough detail of the external events of business process to permit collaboration.

Vocabulary module 34 includes a repository for storing industry specific vocabularies, data dictionaries and semantics to permit transformation between two or more different message structures. Vocabulary module 34 also includes document definitions of predefined documents.

In the preferred embodiment, vocabulary module 34 includes one or more vocabularies expressed as models to permit transformation of messages between different data structures. The data structures and formats can be of any type. For example, U.S. patent application Ser. No. 09/896,125 entitled Data Interchange Format Transformation Method And Dictionary Used Therefor, filed on Jul. 2, 2001, the disclosure of which is incorporated herein by reference, describes an EDI vocabulary expressed in XML format that can be used for data translation between EDI and XML. Such a vocabulary, or any other vocabularies, can be used in connection with the invention.

As noted above, vocabulary module 34 includes definitions which include common values and terms to be used in exchanging documents. Vocabulary module 34 also includes rules which define valid values for various document elements, exception handling, and validation of documents. Vocabulary module 34 is capable of providing translation, restructuring, simple semantic transformation, and complex semantic transformation of documents. Translation refers to changing the data format of a document, such as the translation described in U.S. patent application Ser. No. 09/896,125 referred to above, to express the underlying information in a different data format. Restructuring refers to changing the relationship between various elements in a document. Simple Semantic transformation refers to simple changes in the meaning or context of data, such as in converting from one version of a standard document to any updated version of that same standard document. Complex semantic transformations, on the other hand, refer to transformations between documents in which underlying concepts and meanings are transformed, as discussed in greater detail below.

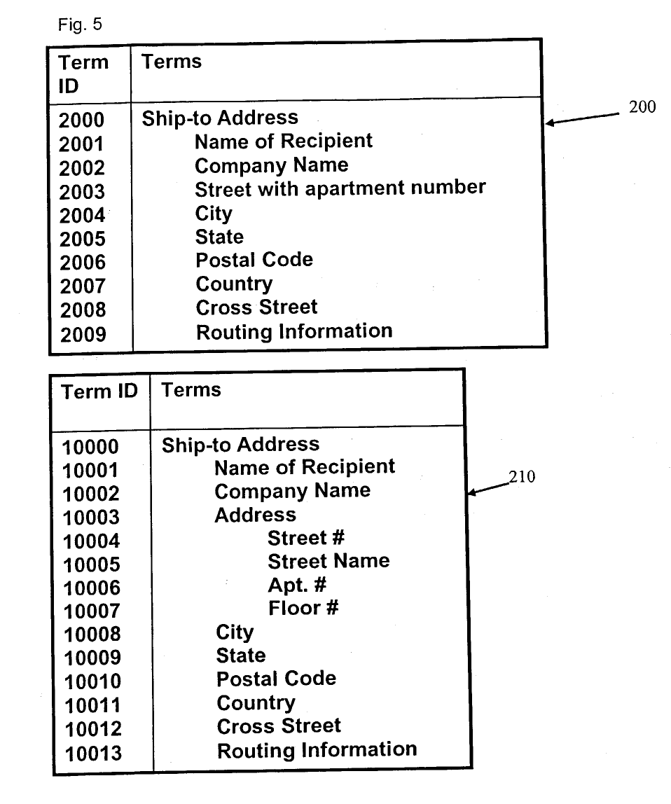

FIG. 5 illustrates two vocabulary models of the preferred embodiment. Vocabulary model 200 represents a “ship to” address of a document. Of course, a vocabulary model can include entire documents, transaction sets, or the like, and thus the ship to address of vocabulary model 200 can be merely a portion of the vocabulary model. Further, there can be any number of vocabulary models as needed by the transformation needs of the specific collaborative application. It can be seen that vocabulary model 200 represents the data elements, i.e. terms and the relationship between the data elements of a specific vocabulary. Also, for reference purposes each term can be assigned a term ID. In particular, vocabulary model 200 includes the term “Ship-to-Address”, having the ID 2000 and other terms, such as Name of Recipient, Company Name, Street and Apartment Number, City, State, and the like, as child terms of the Ship-to Address term.

Vocabulary model 210 also, represent a ship to address. However, it can be seen that the structure of vocabulary model 210 is different from that of vocabulary model 200. Further, the semantics of vocabulary model 200 differ from vocabulary model 210. In other words, different terms have different underlying meanings between the vocabulary models 200 and 210. For example, it can be seen that vocabulary model 210 includes the term Address that has child terms Street #, Street Name, Apt #, and Floor #. These terms are not included in vocabulary model 200. Further, vocabulary model 200 does not have terms that correspond to these terms on a one to one basis. It can be seen that much of the same underlying information is expressed by a document using vocabulary model 200, i.e. an instance of vocabulary model 200, and a document using vocabulary model 210. However, the element names, the structural relationship between the element names, and even the underlying information of individual element names are different between the two models.

In view of the disparities between vocabulary model 200 and vocabulary model 210 noted above, transformation between instances of vocabulary model 200 and instances of vocabulary model 210 require complex transformations that take into account the meaning of each data element of a vocabulary model and the complex relationship between that data element and data elements in other vocabulary models. Such transformations can be accomplished through a graphical user interface for creating expression trees as disclosed in U.S. patent application Ser. Nos. 09/544,973, 09/544,972, and 09/544,971 filed on Apr. 7, 2000, the disclosures of which are incorporated herein by reference.

For example, a transformation can be created to fabricate an output field from multiple input fields or from a portion of a single input field. For each output field to be populated with data, a set of rules to create that field is defined. The rules are built using expressions, i.e. algorithms, that manipulate input parameters in a specific manner to produce a single result. The result may be placed in a output field or used as a parameter to another expression. A tree configuration of the various expressions is created to define the set of rules for any particular transformation. As disclosed in detail in the patent applications referenced above, categories of the expressions can be displayed in a window alongside each of the input and output schema, e.g., vocabulary models 200 and 210 respectively. Each node of the expression tree can represent an expression and can include an icon indicating the type of expression and text describing the specifics of the expression. The expressions can be applied to items in the vocabulary models using the graphical interface disclosed in detail in the above referenced patent applications, or in any other manner, to create transformations to be stored in vocabulary module 34 and to be applied to vocabularies in vocabulary module 34 to effect transformation between instances of vocabulary models 200 and 210 in the form of documents, messages, or the like.

The use of a vocabulary based approach in which vocabulary models express the semantics of documents permits flexible document production and work flows to be achieved. The various vocabulary models and transformations can be represented as a document flow conforming to process model 100.

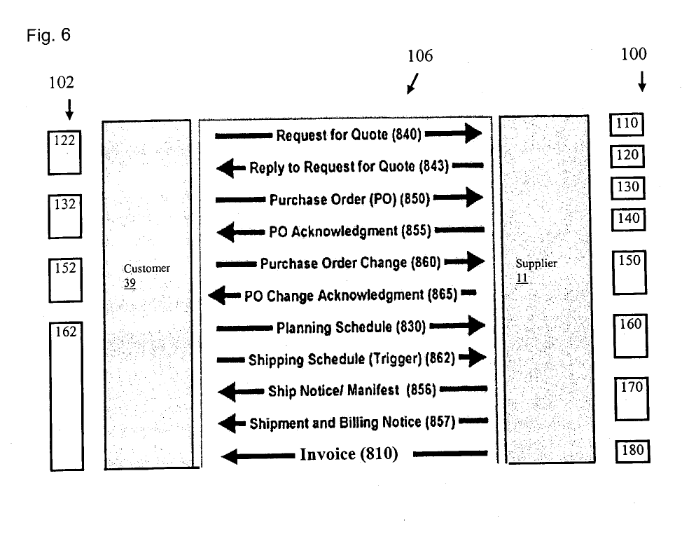

FIG. 6 illustrates an example of document model 106 that can be stored in vocabulary module 34. Document model 106 corresponds to process model 100 of FIG. 2 and services model 102 of FIG. 3. Each arrow in document model 106 represents a document and the related transformation required to provide communication between supplier 11 and customer 39. As illustrated in FIG. 6, document model 106 represents plural documents in a logical order exchanged between the parties and corresponding to the various states of business process model 100. Each document is labeled In FIG. 6 with the corresponding EDI document number for reference only. As noted above, the invention can use any document formats, such as EDI, various forms of XML, or other formats. Note that the states of business process model 100 are illustrated to the right of document 106 and the corresponding services of services model 102 are illustrated to the left of vocabulary model 106. In particular, an outbound document generated by customer 39 can be transformed and transported, via the Internet, or any other communications channel, to a trading partner, such as supplier 11 or repurposed as a Web page for processing. Supplier 11 can then create the appropriate response, i.e. a turnaround document. Of course, supplier 11 and customer 39 can have disparate data formats represented by vocabulary models, such as vocabulary models 200 and 210, in the manner discussed above. The entire process can make use of interactive functional acknowledgment processing to ensure non-repudiation. Additionally, an audit trail of documents can be created so a user can view a log of related transactions and their current state. Further, as will be seen below, documents can be created based on earlier documents. Also, documents can be published or otherwise distributed to any desired party. For example, a shipper or facilities manager can be notified of transaction data and events.

The first document in accordance with document model 106 of the example is a Request for Quote (RFQ). Customer 39 initiates the creation of the RFQ and transmits a copy of this EDI document to integration server 30 in compliance with service 122. This corresponds to state 110 of process model 100. The RFQ is transformed into a corresponding representation by vocabulary module 34, using the methodology described above for example.

Supplier 11 may choose to accept the entire RFQ or accept the RFQ with changes. If supplier 11 chooses to accept the entire RFQ, a turnaround Reply to RFQ document is automatically generated by vocabulary module 34 and sent to customer 39. This corresponds to quote state 120 of process model 100. If supplier 11 chooses to accept the RFQ with changes, a Response RFQ template document can be automatically generated where supplier 11 may go through each line item and select Accept, Reject, Price Change, or Quantity Change using drop-down menus or the like. After supplier 11 has finished editing the line item(s), the changes will be applied to the Reply RFQ document. Vocabulary module 34 then translates this document to a corresponding Reply to Request for Quote and sends the document to customer 39. Note that service 122 defines the touchpoints necessary for customer 39 to participate in the exchange of the RFQ and Reply to RFQ documents with supplier 11.=

Document model 106 now proceeds to state 130 of process model 100 for processing a Purchase Order (PO) in accordance with service 132. Customer 39 initiates the creation of PO document in accordance with service 132 and sends a copy of this document to integration server 30. The PO document is transformed into its corresponding representation by vocabulary module 34 and transmitted to supplier 11. Supplier 11 now has a PO to process. Supplier 11 may choose to accept the entire PO or accept the PO with changes by line items. If supplier 11 chooses to accept the entire PO, a turnaround PO Acknowledgment document is automatically generated. If the supplier chooses to accept the PO with changes, a template document is automatically generated, to permit the supplier to go through each line item and to select either Accept, Reject, Price Change, or Quantity Change. After supplier 11 has finished editing the line item(s). The document is transformed to a PO Acknowledgment and sent to customer 39.

The next transaction that is handled is the 860—Purchase Order Change Request—Buyer Initiated in state 150 of business process model 100. Customer 39 initiates the creation of the 860 PO Change Request EDI document, in accordance with service 152, and sends the document to integration server 30 for processing. The PO Change Request EDI document is transformed into its corresponding XML representation by vocabulary module 34. Supplier 11 now has a PO Change Request XML document to process. The supplier may choose to “Accept” the entire PO and a turnaround PO Change Acknowledgment/Request document is automatically generated, transformed to a PO Change Acknowledgment/Request by vocabulary module 34 and sent to customer 39.

Now, in accordance with service 162 and state 160, a Planning Schedule is generated. Customer 39 initiates the creation of the Planning Schedule and sends a copy of this document to integration server 30 for processing. The Planning Schedule document is then transformed into its corresponding representation and sent to supplier 11. A shipping schedule can also be generated and sent to supplier 11 and any other appropriate parties at this time.

Integration server 30 now generate a Ship Notice/Manifest and sends, the same to customer 39 in accordance with state 170 of business process model 100. Shipment and billing notice 857 can be generated and sent in a similar manner. Supplier 11 initiates the creation of the Invoice document that is based on the Ship Notice/Manifest (state 180). The document is transformed into its corresponding representation and transported to accounts payable systems of customer 39. Note that service 162 defines the Planning Schedule, the Shipping Schedule, the Ship Notice Manifest, the Shipment and Billing Notice and the Invoice from the perspective of customer 39. The process and document flow can continue to accomplish payment remittance, funds transfer and accounting using standard documents such as Application Advice, Application Control Totals, and the like, as illustrated in FIG. 6.

The preferred embodiment permits flexible business processes and document flows to be established between trading partners, even if the trading partners utilize disparate systems. The vocabulary module transforms the documents on the fly and can include plural vocabularies for transforming documents between various formats. The vocabulary module can be modified and customized to meet specific requirements, for example company requirements or industry specific trading requirements. The preferred embodiment allows modification of XML documents using the same information model, making it easy to integrate with trading partners who have different requirements. Further, the ability to link business processes and document flow in a modeling environment permits the business process to be easily modified to accommodate changing business models. Further, truly collaborative applications can be developed in a model driven environment. The use of services corresponding to the model permits trading partners to readily comply with each other's business processes. In other words, a trading partner can develop a collaborative application in a model driven environment and permit other trading partners to comply with the application without exposing the trading partner's business processes to the other trading partners. The business process model, the services model, and the vocabulary model can each be developed in an iterative manner to ensure the proper relationship between each model.

It can be seen that the preferred embodiment provides a modeling environment for development of collaborative applications by capturing collaborative business processes in interrelated models. This allows the business analyst, not the programmer, to focus on the important work of designing business rules and workflow to solve specific business issues. Predetermined process models, vocabularies, workflows and display mechanisms can be provided to facilitate development of collaborative applications. For example, each of these elements can correspond to specific industries and can be modified as necessary to suit trading partners.

The invention can be implemented on any device, such as a personal computer, server, or any other general purpose programmable computer or combination of such devices, such as a network of computers. Communication can be accomplished through any channel, such as a local area network (LAN), the Internet, serial communications ports, and the like. The communications channels can use wireless technology, such as radio frequency or infra-red technology. The various elements of the preferred embodiment are segregated by function for the purpose of clarity. However, the various elements can be combined into one device or segregated in a different manner. For example, software can be a single executable file and data files, or plural files or modules stored on the same device or on different devices. Any protocols, data types, or data structures can be used in accordance with the invention. The invention can be used to design, create, manipulate, test or use any collaborative application can be used in combination with any type of system for affecting business processes or other functions. Any appropriate user interface can be used to design, create, and manipulate models. The underlying code can be written in any language.

The invention has been described through a preferred embodiment. However, various modifications can be made without departing from the scope of the invention as defined by the appended claims and legal equivalents thereof.

What is claimed is:

1. A model driven environment for executing collaborative business applications through which participants can execute business processes, said system comprising:
a business process module operative to execute business process models representing collaborative business processes;
a vocabulary module including a vocabulary model defining common terms and transformations to be used in exchanging documents to be used for transactions; and
a services module including a services model representing external events corresponding to states of the business process models executed by said business process model execution module in conformance with said vocabulary models and corresponding transformations.

2. An environment as recited in claim 1, wherein the participants comprise trading partners.

3. An environment as recited in claim 1, wherein the participants comprise applications.

4. An environment as recited in claim 1, wherein the business process models are in a graphical form

5. An environment as recited in claim 1, further comprising a graphical model development module.

6. An environment as recited in claim 5, further comprising at least one predefined business process model specific to an industry.

7. An environment as recited in claim 1, further comprising a document model representing a flow of documents between trading partners based on said business process model and said vocabulary models.

8 An environment as recited in claim 1, wherein said services model presses the external events as specifications.

9. An executable business collaboration application for executing collaborative business process models, said application comprising
a business process model defining steps and rules of a business process in the form of plural states and transitions between the states;
a vocabulary model including definitions of common terms and transformations to be used in exchanging documents; and
a services model defining external events corresponding to states of business process models and corresponding documents.
